(19) United States
(12) Patent Application Publication
(10) Pub. No.: US 2008/0141946 A1
(43) Pub. Date: Jun. 19, 2008

(54) Animal exerciser

(76) Inventor: Sharon D. Kalani, Torrance, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/641,641

(22) Filed: Dec. 18, 2006

(51) Int. Cl. A01K 15/02

(52) U.S. Cl. 119/700

(57) ABSTRACT

A light-weight animal exercise wheel includes an inside track, a back portion and a connecting portion. A connector can connect to either a removable base or a bracket that can be attached to a fixed structure.

### BACKGROUND

1. Field

The embodiments relate to animal exercisers, and more particularly to a light-weight, space-saving animal exercise wheel.

2. Description of the Related Art

Various devices have been developed to entertain animals and to exercise animals as well. Treadmills have been used for training dogs. Animal wheels have been used to entertain and exercise hamsters and other similarly sized animals that are typically caged.

U.S. Pat. No. D484,284 (“Venson”) illustrates a design for a cat exercise wheel. The actual product described in Venson is made of wood, carpet and metal spokes. The Venson cat exercise wheel is bulky, heavy and costly as well.

### SUMMARY

One embodiment includes a light-weight animal exercise wheel having an inside track, a back portion and a coupling portion. A coupler removably couples to either a removable base or a bracket that is adapted to couple to a fixed structure.

Another embodiment includes a system including an animal exercise wheel with an inside track, a back portion and a coupling portion. A coupler removably couples to either a removable base or a bracket that is adapted to couple to a fixed structure. A variable resistance device is removably connected to the animal exercise wheel.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates a perspective view of an embodiment of an exercise wheel;

FIG. 2 illustrates a close-up view of a track of the exercise wheel illustrated in FIG. 1 having ridges;

FIG. 3 illustrates a side view of the exercise wheel illustrated in FIG. 1;

FIG. 4 illustrates a front view of the exercise wheel illustrated in FIG. 1;

FIG. 5 illustrates a perspective view of another embodiment of an exercise wheel;

FIG. 6 illustrates a close-up view of a track of the exercise wheel illustrated in FIG. 5 having grooves;

FIG. 7 illustrates the embodiment of FIG. 5 without a blown-up view of an inside track;

FIG. 8 illustrates a side view of

FIG. 9 illustrates a perspective view of yet another embodiment of an exercise wheel;

FIG. 10 illustrates a side view of the exercise wheel illustrated in FIG. 9;

FIG. 11 illustrates a perspective view of a wall mount bracket and an exercise wheel embodiment;

FIG. 12 illustrates a side view of the embodiment illustrated in FIG. 11;

FIG. 13 illustrates a perspective exploded view of a wall mount bracket and exercise wheel without a base;

FIG. 14 illustrates a side view of a wall mount bracket and exercise wheel without a base;

FIG. 15 illustrates a perspective view of an embodiment of an exercise wheel without a variable resistance device; and

FIG. 16 illustrates a front view of the embodiment illustrated in FIG. 15.

### DETAILED DESCRIPTION OF THE INVENTION

The invention generally relates to a lightweight animal exercise wheel. Referring to the figures, exemplary embodiments of the invention will now be described. The exemplary embodiments are provided to illustrate the invention and should not be construed as limiting the scope of the invention.

FIG. 1 illustrates an embodiment of an animal exerciser. Animal exerciser 100 is sized to exercise a cat, small breed dog, iguana, bird, or similar sized animal. Wheel 110 includes a track 120 and a back wall 115. Wheel 110 is made of a strong lightweight material, such as plastic, aluminum, carbon fiber, etc. In one embodiment, wheel 110 is a solid material (i.e., one piece). In another embodiment, wheel 110 is molded out of one solid plastic, fiber or metal material. In one embodiment track 120 includes ridges 130 for additional traction. In one embodiment ridges 130 are molded in the wheel 110. In another embodiment, ridges 130 are made of a gripping material, such as rubber. Ridges 130 do not have too much friction so an animal, such as a cat, will not have its claws get stuck to the ridges. Animal exerciser 100 further includes a removable base 140. In one embodiment removable base 140 is tubular shaped and curved. In one embodiment, wheel 110 is sized to accommodate two animals, side-by-side, at the same time. In other embodiments, cross member (not shown) base portions are added for further stability.

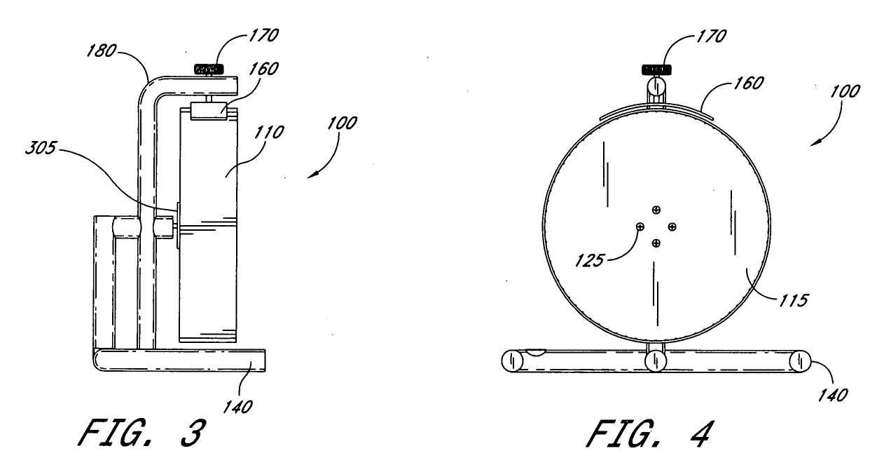

In one embodiment, base 140 is hollowed to allow insertion of sand, water, cement, etc. through cap 150. Base 140 can be made of a plastic, carbon fiber, etc. In another embodiment, base 140 is made of a metal or metal alloy. Animal exerciser includes a plurality of attachment means 125. In one embodiment, attachment means 125 are bolts that are inserted through holes in wall 115. The bolts can vary in size and number without changing the scope of the invention. An example is four holes, five holes, etc. In another embodiment, attachment means 125 are machine screws that screw into an attachment plate 306 that connects to spinning means 305 (see FIG. 3).

In one embodiment animal exerciser further includes a removable variable resistance means. In one embodiment, the variable resistance means includes optional support 180, adjuster 170 and pad 160. To change the resistance of wheel 110, adjuster 170 is screwed down, which in turn forces pad 160 to press against wheel 110. The more the adjuster forces pad 160 against wheel 110, the harder an animal has to work to turn the wheel. This exercises an animal and helps the cat to get stronger leg muscles or helps adjust the speed at which the animal spins the wheel 110. In one embodiment, pad 160 is made of a plastic with a material bottom, such as felt to help wheel 110 turn smoothly when a force is applied from pad 160. In one embodiment, the variable resistance means is removable from base 140. Other embodiments can use other means for variable resistance, such as a belt and tension device or other friction asserting devices

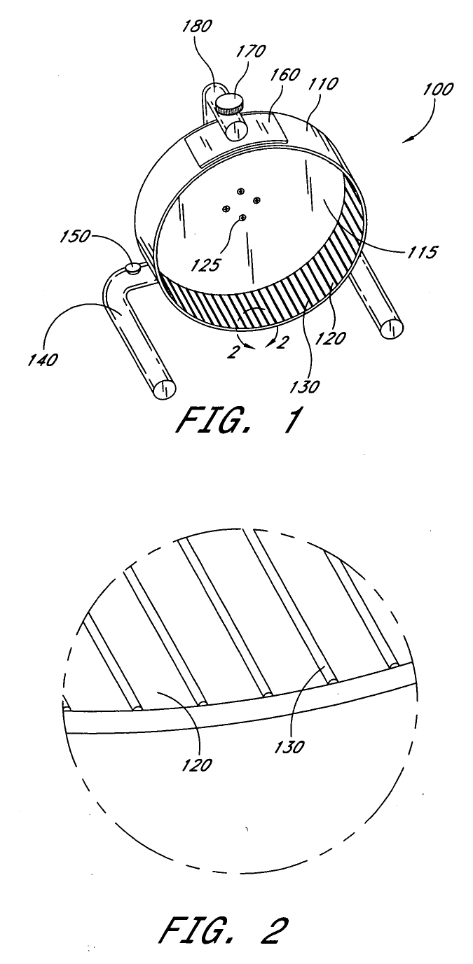

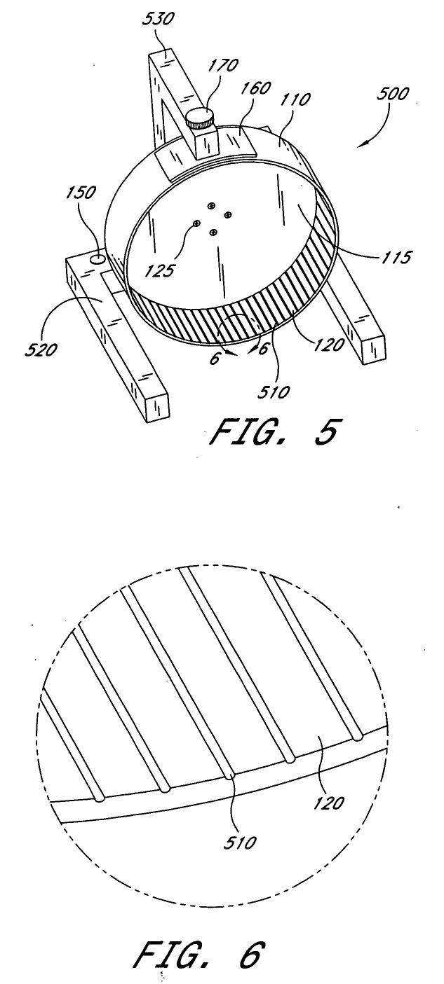

FIG. 2 illustrates a close-up view of track 120 including ridges 130. As illustrated, ridges 130 are slightly raised from track 120. The ridges 130 help an animal with traction. In another embodiment, track 120 includes grooves 510 (see FIG. 5-6). In this embodiment, the grooves have a width such that a typical claw of an animal, such as a cat, cannot get stuck in the grooves to prevent injury. In yet another embodiment, ridges 130 are rubber, gel (or similar material), etc. and inserted into grooves or glued onto track 120. In still another embodiment, ridges 130 are made of a stone type of material to allow an animal (e.g., a small breed dog) to wear down claws without injury. The embodiments are made such that the materials are washable without causing harm to the material.

FIG. 3 illustrates a side view of animal exerciser 100. As illustrated, wheel 110 is connected to base 140 at spinning means 305. In one embodiment, spinning means 305 is attached to a coupler, such as coupler 1410 (see FIG. 14). The spinning means can be a spindle, an axle, a ball bearing device, etc. that is connected to the coupler. Base 140 attaches to wheel 110 such that animal exerciser 110 can be placed closely to a solid object, such as a wall, a door, furniture, etc. Animal exerciser 100 is sized such that it is compact, lightweight, and strong so that animal exerciser 100 is easily moved around from room to room and place to place. FIG. 4 illustrates a direct front view of animal exerciser 100.

In one embodiment animal exerciser emits a sound when wheel 110 spins. The sound can be emitted from a removable bell attached to wheel 110. In another embodiment, a sound chip with a speaker connected to a motion switch and a voltage source (e.g., a battery) can emit different sounds or melodies. In another embodiment, a motion switch connected to a voltage source (e.g., a battery) and a light source can add lights (e.g., solid light, blinking lights, etc.) to wheel 110. The lights (e.g., light emitting diodes) can be imbedded in wheel 110 either on the outside or inside track 120, or back wall 115. In one embodiment, a simple switch allows an animal's owner to turn on/off sound and/or lights.

In another embodiment, a mechanical simple counter is connected to the spinning means 305 to count up on each revolution of wheel 110. An owner can read the counter to see how many revolutions the animal has made. In still another embodiment, a speedometer is connected to spinning means 305 so an animal owner can see the speed of the animal.

FIG. 5 illustrates an animal exercise wheel 500. In this embodiment, base 520 is square shaped. Optional support 530 is also square shaped. In one embodiment, track 120 includes grooves 510. Grooves 510 are lower than the surface of wheel 120. Grooves 510 have a small enough width so that a cat's claw cannot get stuck in a groove. Grooves 510 give additional traction to an animal using animal exerciser 500. In one embodiment base 520 is hollowed to allow insertion of sand, water, cement, etc. through cap 150. Base 520 can be made of a plastic or similar material. In another embodiment, base 520 is made of a metal or metal alloy.

FIG. 6 illustrates a close-up view of track 120 including grooves 510. As illustrated, grooves 510 are slightly lowered from track 120. The grooves help an animal with traction. In another embodiment, track 120 can include other raised or lowered elements in various shapes and sizes to aid in traction (e.g., raised/lowered dimples, crisscrossed grooves/ridges, etc.)

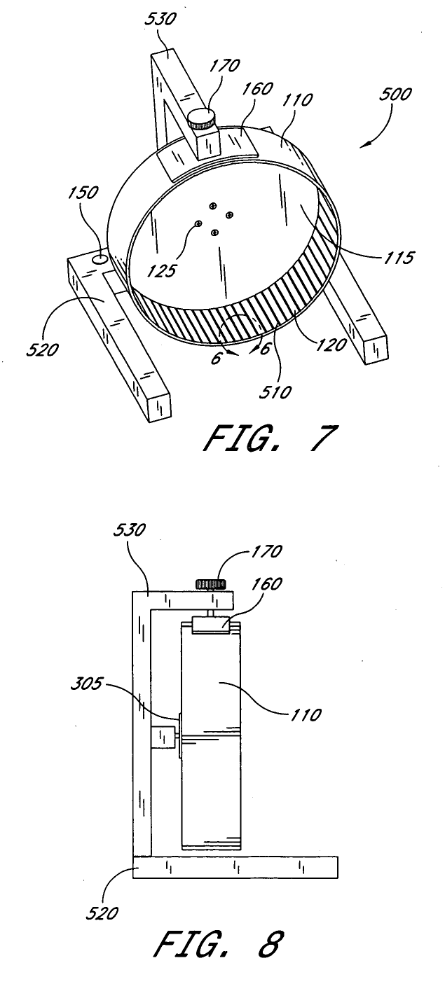

FIG. 7 illustrates the embodiment of FIG. 5 without the blown-up track section, which is fully depicted in FIG. 6. FIG. 8 illustrates a side view of animal exerciser 500.

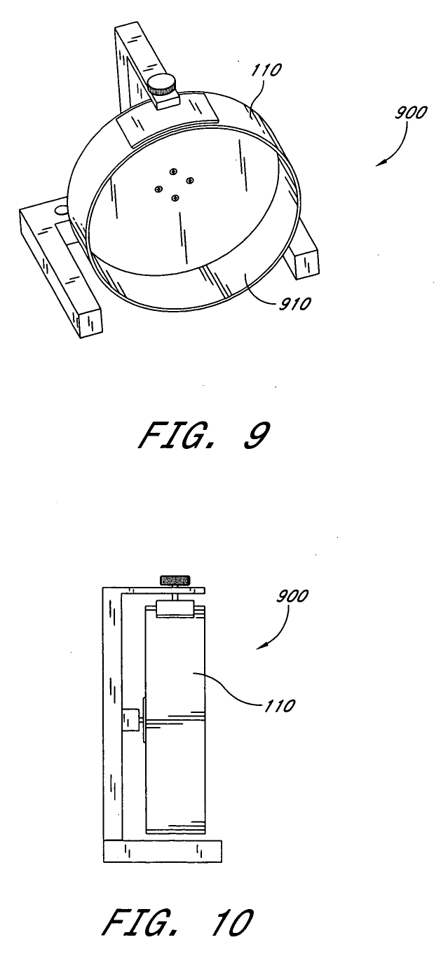

FIG. 9 illustrates an animal exerciser 910. Animal exerciser 910 is similar to animal exerciser 500 except track 910 has a smooth surface. That is, in this embodiment track 910 does not contain ridges or grooves, etc. It should be noted that track 910 does not have a slippery surface. FIG. 10 illustrates a side-view of animal exerciser 900.

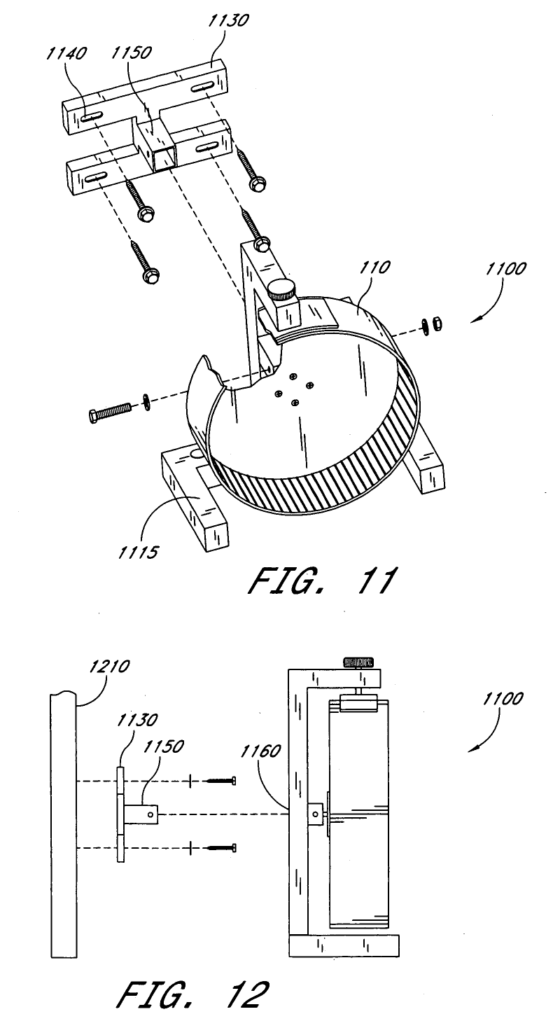

FIG. 11 illustrates another embodiment of an animal exerciser. Animal exerciser 1100 includes base 1115 with a support portion. The support portion (or a coupler connected to wheel 110 in an embodiment where wheel 110 is directly coupled to bracket 1130) has an opening 1160 (see FIG. 12) that allows insertion of a bracket coupler portion 1150 of bracket 1130 to be inserted into opening 1160. Support portion 1120 and bracket coupler portion 1150 have through holes to allow insertion of a fastening means (e.g., screws, bolts, etc.) to secure bracket 1130 to base 1115.

In another embodiment, wheel 110 is couples directly to bracket 1130 without the base portion 1115 or support portion. Bracket 1130 includes openings 1140 that allows a fastening means to be inserted to fasten bracket 1130 to a surface, such as a wall, door, post, etc. Bracket 1130 is compact and allows wheel 110 to be connected closely to a surface to save space. In one embodiment bracket 1130 and base 1115 are made of a rigid material, such as plastic, carbon fiber, etc. In another embodiment, bracket 1130 and base 1115 are made of a metal or metal alloy. While bracket 1130 is illustrated in an “H” shape, other embodiments can vary in designs as long as the connection to a surface and to the wheel 110 is sturdy.

FIG. 12 illustrates a side view of bracket 1130 and animal exerciser 1100. As illustrated, animal exerciser 1100 can be connected with bracket 1130, which in turn can be connected to a surface, such as surface 1210 or directly coupled to surface 1210 without base 1115 and the support.

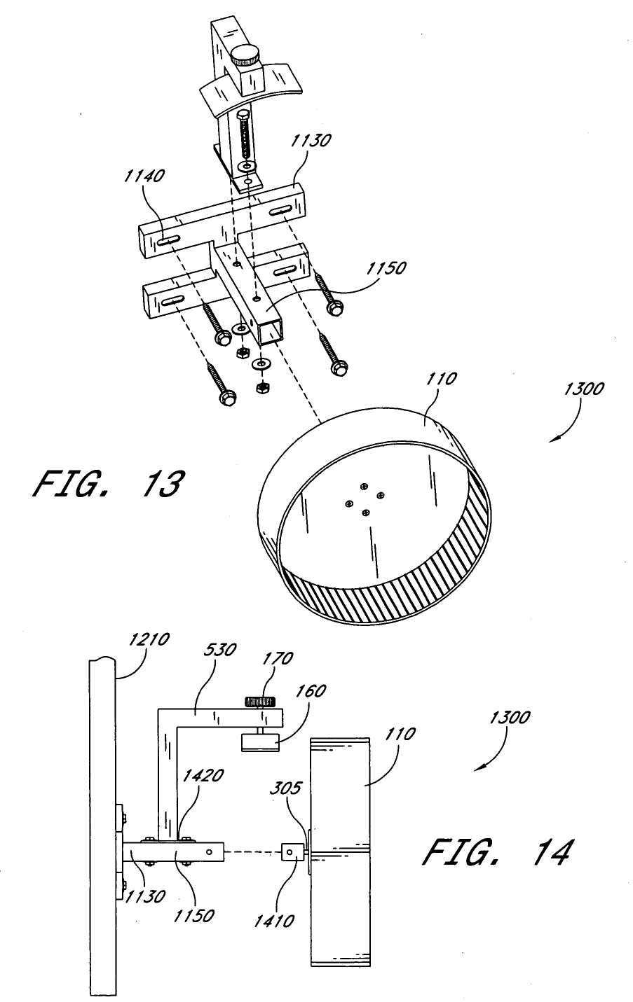

FIG. 13 illustrates an embodiment of an animal exerciser 1300 that does not include a base, such as base 140, 520 or 1115. In this embodiment, wheel 110 is directly connected to bracket 1130, which in turn can be connected to a surface 1210. In one embodiment, bracket 1130 has coupler portion 1150. In one embodiment, coupler 1150 is long enough to accommodate a variable friction resistance device. In another embodiment, bracket 1130 has a length sized to attach wheel 110 such that the distance between a surface that wheel 110 is connected to and wheel 110 is small (e.g., 1 or 2 inches).

FIG. 14 illustrates a side-view of animal exerciser 1300. As illustrated, wheel 110 connects to bracket 1130 with coupler 1410, which is inserted into coupler portion 1150. In this embodiment, support 530 includes a means for connecting 1420 that connects support 530 to coupler portion 1150. In one embodiment, the means for connecting 1420 can be flat and extend outwards from the bottom of support 530 (e.g., a flange, etc.).

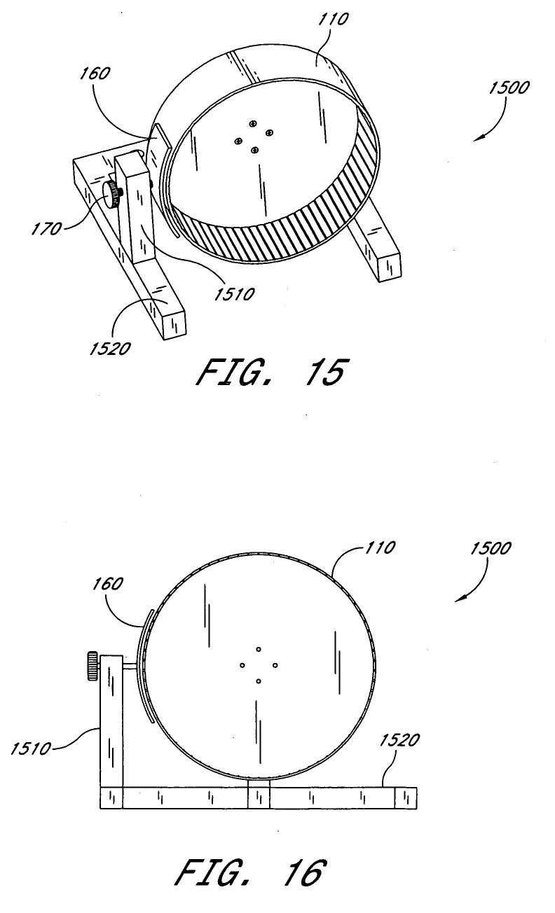

FIG. 15 illustrates an embodiment of an animal exerciser 1500. In this embodiment, variable resistance means is side-mounted. Resistance support 1510 connects to base 1520 on one side (e.g., left side or right side). As illustrated, resistance support 1510 is connected with fastening means (e.g., screws, bolts, etc.) to the left side of base 1520. FIG. 16 illustrates a direct front view of animal exerciser 1500.

The above described embodiments are strong, light weight and can easily be moved about a room or place. With the removable portions (i.e., base, variable resistance, bracket and wheel), the different embodiments are also easily transported. With the removable bracket, an animal owner can easily move the animal exerciser between multiple locations. Also, since the wheel can be constructed as a single piece, the cost of the animal exerciser can be kept down. The different embodiments are not bulky and save place. This comes in handy for apartment residents that do not have a lot of room. The embodiments are easily washable and are made of material that prevents animals from injury (e.g., claws getting stuck in carpet, wood, etc.). When the bracket is used to connect a wheel to a surface, even more space can be saved.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus comprising:
a light-weight animal exercise wheel having an inside track, a back portion and a coupling portion; and
a coupler, the coupler removably couples to one of a removable base and a bracket that is adapted to couple to a fixed structure.

2. The apparatus of claim 1, further comprising:
a variable resistance device coupled to the light-weight animal exercise wheel.

3. The apparatus of claim 1, wherein the inside track includes one of a plurality of traction grooves and a plurality of ridges, the plurality if ridges are one of molded to the inside track and attached as traction inserts.

4. The apparatus of claim 1, further comprising one of a removable sound device and a fixed sound device that emits sound when the light-weight animal exercise wheel turns.

5. The apparatus of claim 1, wherein the fixed structure is one of a wall, a post and a door.

6. The apparatus of claim 1, wherein the light-weight animal exercise wheel is made of one of a plastic material, a metal, a metal alloy, and carbon fiber.

7. The apparatus of claim 1, wherein the back portion is the same diameter as the light-weight animal exercise wheel.

8. The apparatus of claim 1, wherein the inside track is contiguous.

9. The apparatus of claim 1, wherein the light-weight animal exercise wheel is made of one molded as a single piece of material.

10. The apparatus of claim 1, wherein the light-weight exercise wheel is adapted to exercise one of a cat and a small breed dog.

11. The apparatus of claim 1, wherein the removable base includes a hollow interior.

12. The apparatus of claim 11, wherein the removable base includes a cap, and the hollow interior adapted to hold one of sand and water inserted through the cap.

13. A system comprising:
an animal exercise wheel having an inside track, a back portion and a coupling portion;
a coupler, the coupler removably couples to one of a removable base and a bracket adapted to couple to a surface; and
a variable resistance device removably coupled to the animal exercise wheel.

14. The system of claim 13, wherein the inside track includes one of a plurality of traction grooves and traction ridges, the traction ridges are one of molded with the inside track and coupled as traction inserts.

15. The system of claim 13, further comprising one of a removable sound device and a fixed sound device that emits sound when the animal exercise wheel turns.

16. The system of claim 13, wherein the animal exercise wheel includes imbedded lights coupled to a power source and a motion switch, the imbedded lights light up when the animal exercise wheel turns.

17. The system of claim 13, wherein the light-weight exercise wheel is adapted to exercise one of a cat and a small breed dog.

18. The system of claim 13, wherein the surface is one of a wall, a post and a door.

19. The system of claim 13, wherein the base includes a hollow interior.

20. The system of claim 19, wherein the base includes a cap, and the hollow interior is adapted to hold one of sand and water inserted through the cap.
